(19) United States
(12) Patent Application Publication
(10) Pub. No.: US 2010/0270797 A1
(43) Pub. Date: Oct. 28, 2010

(54) WAVE ENERGY APPARATUS

(76) Inventors: Peter Kenneth Stansby, Nether Alderley (GB); Alan Charles Williamson, Manchester (GB); Timothy John Stallard, Waton (GB)

Correspondence Address: MCANDREWS HELD & MALLOY, LTD, 500 WEST MADISON STREET, SUITE 3400, CHICAGO, IL, 60661, US

(21) Appl. No.: 12/771,463

(22) Filed: Apr. 30, 2010

Related U.S. Application Data
(63) Continuation of application No. PCT/GB2008/003702, filed on Oct. 30, 2008.

(30) Foreign Application Priority Data
Nov. 2, 2007 (GB) 0721623.7

(51) Int. Cl. F03B 13/18; H02P 9/04

(52) U.S. Cl. 290/42; 290/53

(57) ABSTRACT

In a wave energy apparatus vertical movement of a float suspended in a body of water drives a power generator. Motion of the float is controlled by taking advantage of the movement of water on the upper surface of the float body. The upper surface can be used to generate hydrodynamic forces acting downwardly against the upward forces acting on the lower surface of the float body, effectively damping its movement in the presence of waves that might otherwise provoke undesirably large vertical movement of the float. The movement of water onto the upper surface can be controlled by adjusting the depth at which the float is suspended.

This invention relates to the extraction of energy from waves, particularly to wave energy apparatus in which vertical movement of a float suspended in a body of water drives a power generator. Such apparatus are disclosed in International Patent Publication Nos: WO 2005/038244 and WO 2006/109024, the disclosures whereof are hereby incorporated by reference. The present invention is concerned with the movement of the float of such apparatus in the water, in different wave conditions.

The movement of a float in sea water can be of undesirably large extent, as the nature and size of waves in the water vary. The patent publications referred to above address issues relating to the lateral stability of floats. The present invention is directed primarily at controlling the float's vertical motion.

According to the present invention, the float motion in wave energy apparatus of the kind described above is controlled by taking advantage of the movement of water on the upper surface of the float body. The upper surface can be used to generate hydrodynamic forces acting downwardly against the upward forces acting on the lower surface of the float body, effectively damping its movement in the presence of waves that might otherwise provoke undesirably large vertical movement of the float. The movement of water onto the upper surface can be controlled by adjusting the depth at which the float is suspended. In most embodiments of the invention therefore, the upper surface of the float body is designed such that its area when resolved parallel to the lower surface is less than that of the lower surface. This can be very easily achieved by including an element or stem projecting from the upper surface of the float body which pierces the water surface when the upper surface of the float is submerged. It can also be achieved by shaping the upper surface of the float such that a part thereof projects upwardly to pierce the water surface when the float is immersed or when suspended in still water. When suspended in still water the cross section of the element or stem, or the projecting part of the float upper surface at the water surface is preferably in the range 0.01 to 0.2 times the mean cross section of the float body. If at least the stem cross section is circular, this sets the minimum diameter of the stem or of the projecting row at the surface at around 0.1, and a maximum of around 0.4, times the float body diameter. Preferably it is 0.2 to 0.3 times the float diameter. Generally, the larger the cross-section of the stem, the larger the changes of mass that are required to alter the behaviour of the float in the waves. The float body cross section will normally be constant, and usually circular, although variations are possible. Such variations will typically include shapes which taper toward the top of the float.

The upper surface of the float body may take any suitable shape, including flat, convex or conical. We have found that a conical upper surface has provided effective damping, the cone angle being in the range 90 to 150°. A cone angle of 120° is particularly preferred.

Where the upper surface meets the side of the float, it is preferred that a sharp corner or edge is created. This enhances the sloshing effect, generates turbulence around the periphery, and downwardly directed hydrodynamic forces on the float upper surface. However, floats without such a sharp edge can be useful. In this variant the float has the overall shape of a teardrop with the float upper surface merging with and into a continuous sidewall of the float body. An element or stem can extend from the upper surface, but can be perceived as no more than a continuation of the upper surface. The float can of course be suspended directly from the apex of the upper surface.

Typically the float base will be substantially flat with a chamfered periphery joining with a cylindrical outer shape. Preferred base shapes have a flat central section of area at least one fourth of the cross-section of the float at its base. Other convex shapes such as dome can also be used, one such option being a base cross-section defining an ellipse. Concave shapes for the base would not normally be used. The cylindrical side of the float will normally be of constant diameter, but can converge towards the top.

The depth at which the float is suspended in the water can be adjusted by altering its effective weight. This can be accomplished either directly by shifting ballast to or from the float, and the ballast can be water from the body in which the float is suspended. A pump mechanism can be installed within the float to take on or remove water, but it can also be taken or removed through an element or stem of the kind referred to above extending from the upper surface of the float. As in the practice of the invention the float will normally be suspended from a gantry of some kind, taking ballast to or from the float, or power to a suitably located pump mechanism in the float will be a relatively straightforward exercise. However, because the float will normally be suspended in the water by a mechanism including a counterweight for the float, the effective weight of the float can also be easily adjusted by altering the weight of the counterweight.

Adjusting the effective weight of the float alters the natural frequency of the float. The natural period of the float is mainly determined by the system mass and wetted diameter and in the method of the invention the natural period of the float system is preferably less than that of the prominent wave. When the upper surface of the float is submerged for part of the wave cycle, the vertical oscillation of the float will be reduced. This is the desired configuration in seas with medium to large waves.

In some circumstances it is beneficial to lower the centre of gravity of the float body and this can be accomplished by suspending a keel from the float body. The keel should be shaped to offer least resistance to vertical motion through the water, but can be adapted to resist lateral oscillatory motion by bearing fins or ribs. It would normally be elliptical, spherical or otherwise bulbous in general outline, and could be spaced from the float body by means of a rigid element that could itself bear fins or ribs, or even by a flexible elongate element such as a chain. A keel could also be in the form of a solid cylindrical mass, attached to the float base and concentric with the float, having a diameter small in relation to the float diameter. In some embodiments the mass of the float as a whole can be concentrated in the keel. This will provide maximum stability while at the same time provide for maximum response of the float as a whole to moving waves at the surface. The lower surface of the float body will be as large as is reasonably possible to maximise its response.

All the surfaces of the float will normally be substantially smooth or at least uninterrupted. However, some surface profiling can be used if appropriate. Ribs or grooves can be formed on the upper surface of the float to channel water flowing thereover. Ribs or grooves can also be formed on the side wall of the float to channel water as the float rises and falls.

The invention will now be described by way of example and with reference to the accompanying schematic drawings wherein:

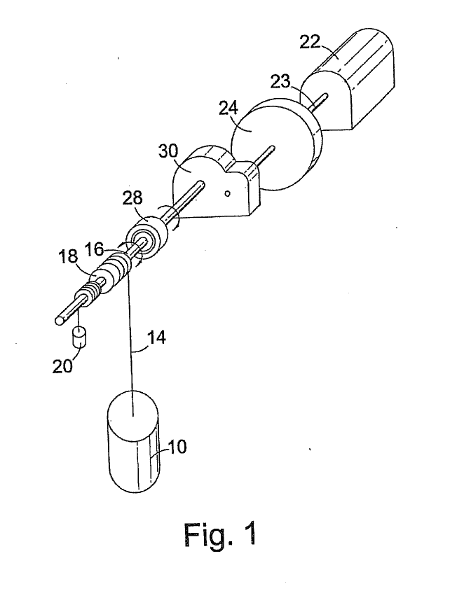

FIG. 1 is a perspective view of a wave energy apparatus of the kind disclosed in International patent publication No. WO 2005/038244; and

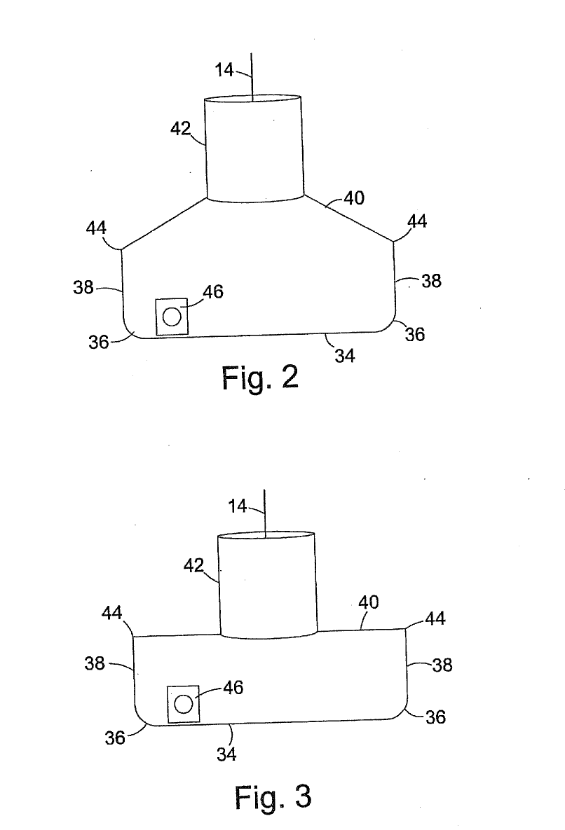

FIGS. 2 to 6 are cross-sectional views of different floats that can be used in accordance with the invention in the apparatus of FIG. 1.

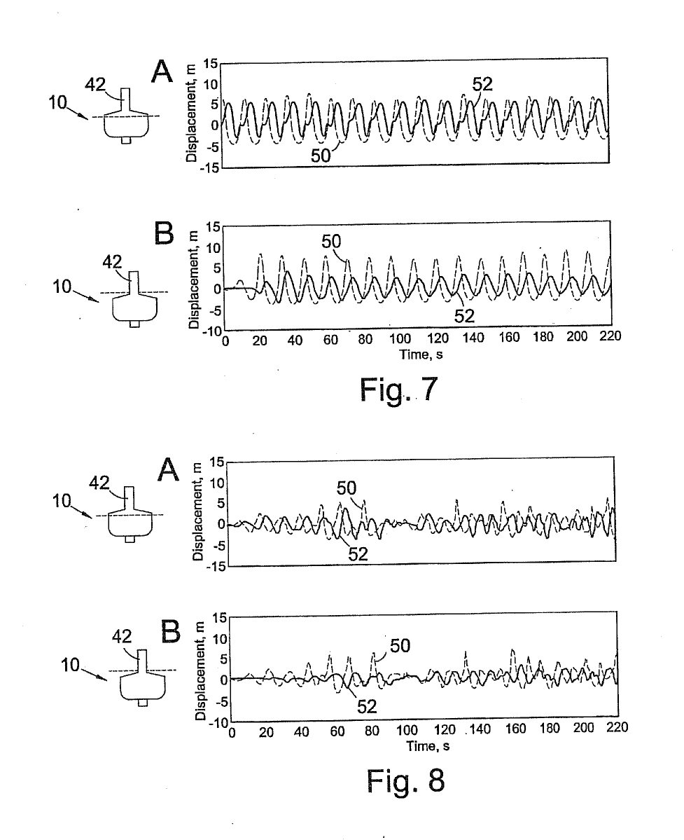

FIGS. 7, 8 and 9 illustrate how the movement of a float of the kind shown in FIG. 2 can be modulated by lowering it in the body of water.

In the apparatus shown in FIG. 1, a float 10 is suspended from a structure (not shown) by a cable 14 which extends around a pulley 18 mounted on a drive shaft 16. The float 10 is adapted to be suspended in a body of water subject to movement, and adapted to rise and fall with such movement. It does not though, have to be on or immersed in the water at all times. As the float 10 rises, slack in the cable 14 is taken up by a counterweight 20 also mounted on the shaft 16, but on a cable around a pulley in the opposite sense to the cable 14 supporting the float 10. The drive shaft 16 is connected to an electricity generator 22 through clutch/free wheel device 28 and a gearbox 30. The clutch 28 is caused to engage and disengage the connection of the drive shaft 16 with the generator 22 by means of a clutch and/or a freewheel device. By this means, vertical movement of the float in the body of water is converted into rotational movement of the shaft which is used to generate electricity in the generator. A separate flywheel 24 on the shaft 23 between the gearbox 30 and the generator 22 provides momentum to maintain rotation of the shaft when it is not being driven by the movement of the float 10. Reference is directed to Patent Application No: WO 2005/038244, incorporated herein by reference, for further discussion of the operation of apparatus of the kind illustrated in FIG. 1.

The present invention is concerned particularly with the manner in which the moving water imparts movement to the float 10 in a controlled manner. Particularly, it is concerned with the manner in which movement of the float can be controlled in extreme conditions. In stormy weather, large waves can cause excessive oscillations of the float, putting at risk the structure upon which it is supported and of course, any operating personnel in the vicinity.

In each of FIGS. 2 to 5 the float 10 lower surface 34 extending via a chamfered edge or edges 36 to a generally cylindrical side wall or side walls 38. Generally, the cross-section of the float will be circular, and the side wall 38 either cylindrical or slightly conical, for the reasons given above. In all four examples, the vertical length of the sidewall or walls 38 is less than the lateral diameter of the float. Preferably the float diameter is greater than the height of the wall or walls 38, normally by a factor of at least 2. A typical float of the type shown in FIG. 2, has a mass of 250 tonnes, and a cylindrical cross-section of diameter around 10 m with a wall height of around 4.0 m. The diameter of the stem 42 is around 2 m. As shown, it has a height of around 4 m, but this could be much greater, typically 7 or 8 m. The chamfered edge or edges 36 reduce turbulence and maximise the upwardly directed hydrodynamic forces on the float.

In the example of FIG. 2, the upper surface 40 of the float takes the form of a frusto conical section extending from the edge 42 of the sidewall to the element or stem 44 which projects upwardly and centrally of the float. The cone angle of the section is approximately 120°, making the inclination of the upper surface 40 from the lower surface 34, around 30°.

When used in wave energy apparatus of the kind illustrated in FIG. 1, the float 10 of FIG. 2 will ideally be suspended partially submerged in a body of water, and the upper surface 40 above the waterline. As the float rises and falls in correspondence with wave motion in the body of water, water will wash over the upper surface 40 and as it does so, generate downward forces on the float acting against the upward forces on the lower surface. This results in a damping effect, which progressively increases with the amount of water washing over the upper surface 40. This effect can be controlled by adjusting the depth at which the float is suspended in the body of water. In order to generate maximum energy from the wave motion, it is of course desirable to keep the damping effect to a minimum. Thus, in relatively calm weather with small to medium waves the float is suspended as near the surface as possible to maximise power output. However, with larger waves movement of the float can become excessive, and some control is required. To achieve this the float is lowered into the body of water, thereby increasing the amount of water sloshing over the upper surface and generating downward hydrodynamic forces counteracting the upward forces acting on the lower surface 34. Normally the geometry of the float is such that the hydrodynamic downward forces never match or exceed the upward forces on the float, and this can be accomplished by establishing an arrangement in which the upper surface when resolved onto a plane parallel to that of the lower surface 34 is always smaller in area. In the embodiment described this is assured by the presence of the element or stem 42 that projects from the upper surface. This stem or element should normally be surface piercing when water is impinging on the upper surface 40. However the stem is not essential if the top of the upper surface itself is surface piercing at least for part of a wave cycle.

While the edge or edges between the lower surface 34 and the side or sides 38 are chamfered to minimise turbulence around the periphery of the lower surface 34, around the upper surface 40 the edge or edges 44 are made sharp. The intention here is to create turbulence as water impinges on the float, to generate downwardly directed hydrodynamic force on the peripheral portion of the upper surface 40.

The depth at which the float 10 is suspended in the water can be most easily adjusted by altering its effective weight. In the apparatus as shown in FIG. 1, the mass of the counterweight 20 may be altered thereby altering the effective weight of the float 10 in the body of water. Alternatively, ballast may be moved to and from the float, and such ballast is conveniently water from the body in which the float is suspended. A pump 46 may be housed in the float and with suitable valving (not shown) pump water to and from a chamber in the float to alter its weight.

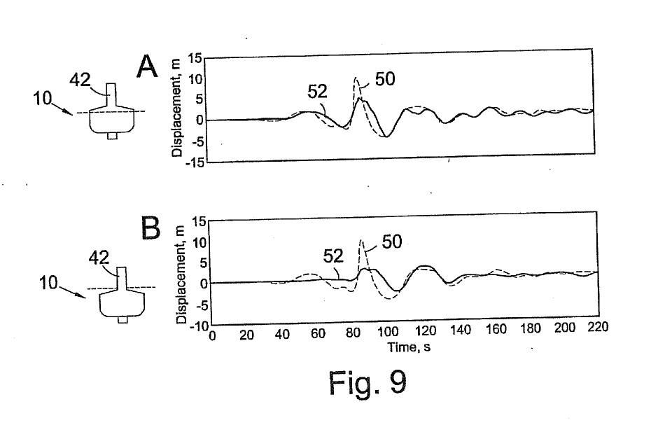

We have found that the vertical movement of the float may be substantially stabilised in adverse wave conditions by lowering the depth at which the float is suspended in the water. The preferred depth is that at which in still water, the stem or upper surface of the float projects upwardly from the float body with its cross sectional area at the water surface being in the range 0.01 to 0.2 of the mean cross sectional area of the float body. Thus, the preferred depth in still water of the float illustrated in FIG. 2 is that at which only the stem, of diameter 2 m pierces the water surface with the entirety of the float body beneath the surface. The effect of this depth selection is illustrated in FIGS. 7, 8 and 9. Each shows the movement of a float of the kind shown in FIG. 2 in response to regular wave movements (FIG. 7); irregular wave movements (FIG. 8) and a sudden large wave (FIG. 9). FIG. 7 shows two graphs with the movement of the float (line 52) superimposed over the substantially regular wave motion (line 50). As can be seen, the amplitude of the wave is reasonably constant and does not exceed 10 m. With the effective mass of the float such that the upper surface of the float body is above water level in still water (FIG. 7A), the amplitude of the float movement (line 52) is a little less, peaking at around 5 m. When the float is lowered in the water such that when in still water only the stem 42 pierces the water surface (FIG. 7B), with the remainder of the float immersed, the amplitude of the float movement is significantly reduced to around one third of the wave amplitude; around 2 m. While this suggests a significantly reduced energy output, in practice there would be little if any loss as the reduced amplitude motion of the float will still be more than sufficient to drive a generator at a normal maximum capacity.

In the same way as does FIG. 7, FIG. 8 illustrates float movement superimposed over wave movement with the depth of the float being set in still water with the float at the surface (FIG. 8A) and with the float body submerged such that only the stem 42 pierces the water surface (FIG. 8B). As can be seen, by submerging the float body the amplitude of its vertical movement in response to the wave motion is moderated and stabilised. FIG. 9 similarly illustrates how lowering of the float can reduce the impact of a large and unexpected wave, again reducing the amplitude of the float movement to tolerable levels, broadly consistent with those provoked in response to a regular wave (FIG. 7).

The benefits of reducing the amplitude of the float movements are considerable. While as noted above there is no significant loss in power generation, extreme movements of the float are avoided. This significantly reduces the strain on the support mechanisms for the float, the gantry and the generator couplings, and also the space within which the float can be suspended in the water. This is important as where multiple floats are used in an array, the manner in which the movement of one float can influence the movement of another must be accounted for. A typical array, of the kind disclosed in International Publication No: WO 2006/109024, referred to above, can have a total of twenty five floats of the kind illustrated in FIG. 2, and their interaction can result in an increase in the amount of energy generated, relative to the amount generated by twenty five single floats operating quite independently.

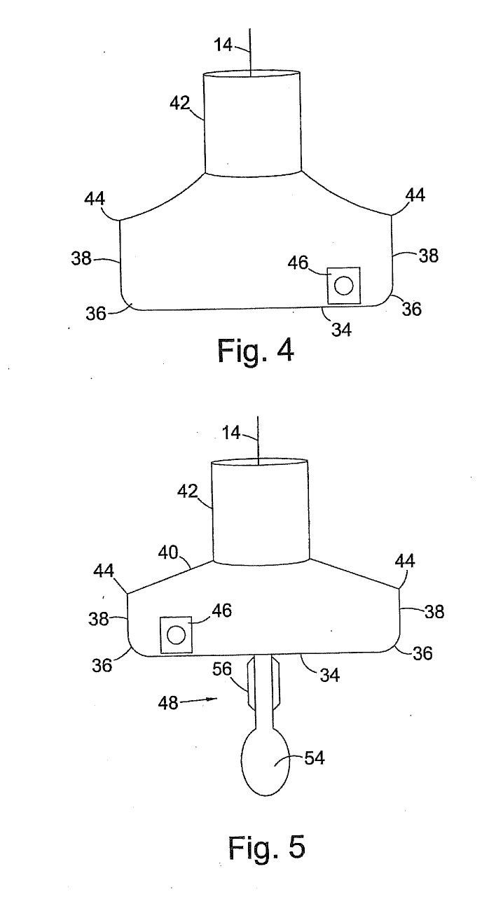

In the example of FIG. 3, the upper surface 40 of the float 10 is substantially flat. FIG. 4 shows an example in which the upper surface 40 has a concave-conical shape. This shape maximises the hydrodynamic forces acting downwardly on the float at its peripheral area, with the effect being reduced as the impinging water moves closer to the centre or the stein 42.

The float shown in FIG. 5 incorporates an additional feature. A keel 48 depends from the float to a bulb 54. The depth at which the keel is suspended below the float is relatively high to maximise its stabilizing effect, and the mass of the float insofar as is possible, is concentrated in the bulb 54. With this additional stability, the float can be suspended in the body of water with its base 34 closer to the water surface, thereby maximising the conversion of wave energy into vertical movement of the float and thereby generation of power. The keel 48 can be formed with fins or ribs 56 to resist lateral movement, without impeding vertical movement. Fins or ribs can also or alternatively be fitted to the bulb 54. The keel might be replaced by a flexible element such as a chain. The bulb 54 thus provides weight and a stabilising effect.

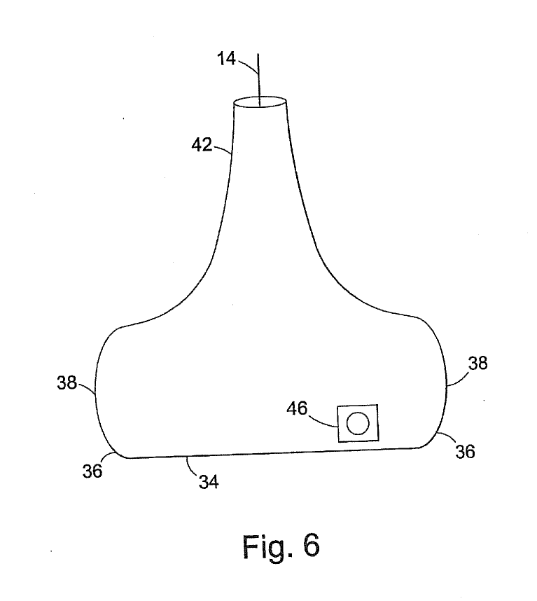

FIG. 6 shows a float in which the upper surface 40 extends to form the element or stem from which it is suspended. The upper surface also merges with and into the continuous sidewall 38, thus removing the edge 44. In all other respects the float is the same as that of FIG. 4, and the upper surface 40 can include an intermediate frusto conical section.

It will be noted that whereas the float 10 in the known apparatus of FIG. 1 is shown as a solid cylinder whose axial length is greater than its diameter, in the examples of floats used in accordance with the present invention, the height is significantly less than a relevant lateral dimension. The reason for this is the exploitation of the upper surface of the float as a component in a damping mechanism effective when the float is suspended in stormy waters. Adjustment of the depth at which the float is suspended enables an apparatus to select when the damping effect is applied.

1-13. (canceled)

14. A method of controlling the vertical motion of a float suspended in a body of water, the float having a mean cross-sectional area between a lower surface and an upper surface that includes an upwardly projecting stem, the cross-sectional area of the stem being in the range 0.01 to 0.2 times the mean cross-sectional area of the float, in which method vertical movement of the float provoked by motion of the water drives a power generator, and the depth at which the float is suspended is adjusted relative to the amplitude of waves in the water to control the movement of water on the upper surface of the float, and wherein the effective mass of the float is such that when it is at rest in still water the stem projects above the water surface.

15-20. (canceled)

21. A method according to claim 14 wherein the float defines a chamber and its mass is adjusted by the movement of ballast to and from the chamber.

22. A method according to claim 14 wherein the float is suspended in the water by a mechanism including a counterweight for the float, and wherein the effective weight of the float is adjusted by altering the counterweight.

23. Wave energy apparatus comprising a float suspended in a body of water and in which vertical movement of the float provoked by motion of the water is linked to a power generator, the float having an upper and a lower surface with a stem projecting from the upper surface and oriented to pierce the water surface when the float body is immersed, the ratio of the cross-sectional area of the stem to the mean cross-sectional area of the float body being in the range 0.01 to 0.2, and wherein the depth at which the float is suspended in the water is adjustable while the float is in the water, the apparatus including means for effecting such adjustment.

24.-26. (canceled)

27. Apparatus according to claim 23 wherein said range is 0.04 to 0.09.

28. (canceled)

29. Apparatus according to claim 23 wherein the upper surface of the float converges upwardly towards the stem.

30. Apparatus according to claim 29 wherein the upper surface of the float is conical.

31. Apparatus according to claim 29 wherein the lower surface of the float is substantially flat and the upper surface is inclined to the lower surface of an angle of 10° to 45°.

32-36. (canceled)

37. Wave energy apparatus according to claim 23 wherein the float comprises a main body defining said mean cross-sectional area, and a keel suspended from the main body.

38. Apparatus according to claim 37 wherein the keel is suspended on an element having fins for minimising lateral movement of the float.

39. Apparatus according to claim 37 wherein the keel is suspended on a flexible elongate element.

40. (canceled)

41. Apparatus according to claim 23 wherein the float is suspended in the water by a mechanism including a counterweight for the float, and wherein the effective weight of the float is adjusted by altering the counterweight.

42. Apparatus according to claim 23 wherein the float upper surface around the stem is flat.

43. Apparatus according to claim 23 wherein the stem projects from a central location on the upper surface of the float body.

44. Apparatus according to claim 23 wherein the lower surface of the float has a flat central section bounded by a curved peripheral annular zone.

45. Apparatus according to claim 43 wherein the flat central section has an area of at least one fourth of the cross-section of the float at its base.
